(19) United States
(12) Patent Application Publication
(10) Pub. No.: US 2006/0226069 A1
(43) Pub. Date: Oct. 12, 2006

(54) Waste water treatment apparatus

(76) Inventor: Mijodrag Gordic, Burnaby (CA)

Correspondence Address: LONG AND CAMERON, SUITE 1401 - 1166 ALBERNI STREET, VANCOUVER, BC, V6E 3Z3, CA

(21) Appl. No.: 11/101,393

(22) Filed: Apr. 8, 2005

(51) Int. Cl. C02F 3/02

(52) U.S. Cl. 210/615; 210/151

(57) ABSTRACT

A waste water treatment apparatus has a treatment tank and a solids retainer baffle downwardly inclined longitudinally of the tank and separating the interior of the tank into an upper region and a lower region. A waste water inlet duct communicating with the lower region of the tank and a treated water outlet duct extends out of the upper region of the tank. An air supply ductwork communicates with air outlets in the lower region of the tank for promoting aerobic digestion in the lower region by microbes on a microbe growth medium between the baffle and the air outlets. Solids from the waste water are retained by the baffle in the lower region while treated waste water is allowed to escape past the lower end of the baffle to the treated water outlet duct.

### BACKGROUND OF THE INVENTION

1. Field of the Invention

The present invention relates to a waste water treatment apparatus.

2. Description of the Related Art

In the treatment of domestic sewage and other waste water, it is known to employ an aerobic waste water treatment tank into which the waste water is discharged. In the tank, the waste water is subjected to an aeration process, which causes bacterial colonies in the tank to digest solid organic matter in the waste water. The thus-treated waste water may then pass through a conical filter into a clarification chamber, while solids in the waste water drop back from the clarification chamber into the aerobic treatment tank. From the clarification chamber, treated effluent may outflow to a disposal system.

It is an object of the present invention to provide a novel and improved aerobic waste water treatment tank apparatus.

### BRIEF SUMMARY OF THE INVENTION

According to the present invention, there is provided a waste water treatment apparatus, comprising a treatment tank having a solids retainer baffle downwardly inclined longitudinally of the tank. The baffle divides the tank into upper and lower regions and a waste water inlet duct communicates with the lower region of the tank, while a treated water outlet duct extends out of the upper region of the tank. A plurality of air outlets are located in the lower region of the tank and an air supply ductwork communicates with the air outlets. A microbe growth medium is located between the ramp and the air outlets. In operation, untreated waste water introduced into the lower region of the tank is treated by the microbe growth and solids from the waste water are retained by the baffle in the lower region of the tank. The treated waste water rises from the lower region of the tank past the lower end of the solids retainer baffle and is removed form the upper region of the tank through the outlet.

### BRIEF DESCRIPTION OF THE DRAWINGS

The invention will be more readily understood from the following description of an embodiment thereof given, by way of example only, with reference to the accompanying drawing, in which:—

FIG. 1 shows a diagrammatic view taken in vertical cross-section through a waste water treatment tank embodying the present invention: and

FIG. 2 show a view taken in cross-section along the line 2-2 of FIG. 1; and

FIG. 3 shows a diagrammatic view in vertical cross-section through a modification of the waste water treatment tank of FIGS. 1 and 2.

### DESCRIPTION OF THE PREFERRED EMBODIMENT

Referring to FIG. 1, there is shown an elongate aerobic waste water treatment tank indicated generally by reference numeral 10, provided with three access hatches 11.

There is an inclined solids retainer baffle 20, which extends across the width of the tank 10 and extends longitudinally of the tank from an upper end 22 of the baffle 20 to a lower end 24 of the baffle 20. The baffle 20 functions to diagonally divide the tank 10 into two regions, namely a lower region indicated generally by reference numeral 30 and an upper region indicated generally by reference numeral 35. The baffle 20 comprises a first or upper portion 26 and a second or lower portion 28. The first portion 26 of the baffle 20 extends from the upper end 22 of the baffle 20 and the second portion 28 of the baffle 20 extends to the lower end 24 of the baffle 20, which is spaced from the inner surface of the tank 10 by a narrow liquid escape gap 25.

The first portion 26 of the baffle 20 is generally longer than the second portion 28 of the baffle 20, and the second portion 28 is generally inclined at a steeper angle than the first portion 26. The first portion 26 supports at its underside an array of bacteria growth media 40 suspended from the first portion 26 of the baffle 20. In this embodiment of the invention, the bacteria growth media 40 is in the form of plastic pipes. However, other media suitable for supporting bacterial growth may be substituted.

A waste water inlet pipe 12 for discharging untreated waste water, for example domestic sewage, into the tank, communicates with the lower region 30 of the tanks 10. A waste water outlet pipe 14 for extracting the treated waste water from the tank, communicates with the upper region 35 of the tank. In this embodiment of the invention, a vertical duct 15 extends upwardly from an open lower end 16 and communicates with the waste water outlet pipe 14 in the form of a Tee. However, this configuration may be altered by replacing this Tee by a filter.

An air supply ductwork for supplying compressed air from an air pump 52 to the tank comprises of a vertical air supply duct 53 which extends vertically downwardly to a horizontal air supply duct 54 which runs longitudinally of the tank and communicates with a plurality of vertical air supply ducts 56 spaced apart longitudinally and transversely of the tank 10 in the lower region 30 of the tank and communicating with horizontal air supply ducts 57 in the lower region 30. The ducts 57 are provided with air discharge nozzles 60 near the bottom of the tank 10. In this embodiment of the invention, the ductwork is comprised of ¾″ PVC pipe. However, other suitable piping materials may be substituted.

The aerobic waste water treatment tank 10 functions as follows:—

Untreated waste water is introduced into the tank 10 via the waste water inlet pipe 12, which is located in the vicinity of the upper end 22 of the baffle 20 and communicates with the lower region 30 of the tank 10, thereby discharging the untreated waste water into the lower region 30 of the tank 10.

Air flows from the air pump 52 down the vertical air supply duct 53 and through the horizontal air supply ducts 54 and 57 and the vertical air supply ducts 56 and is discharged from the air outlet nozzles 60 so as to bubble upwardly through the lower region 30 of the tank 10 to promote treatment of the waste water via aerobic digestion of organic solids in the waste water by bacteria grown on the growth media 40 in a manner well known in the art. Undigested solids from the waste water are retained in the lower region 30 of the tank 10 by the solids retainer baffle 20 and settle at the bottom of the tank 10. The settled solids are pumped out of the tank 10 once a certain level of accumulation is reached.

The treated waste water flows below the lower end 24 of the baffle 20 through the liquid escape gap 25 and into the upper region 35 of the tank 10, and then flows up the vertical duct 15, thereby restricting the discharge of gas from the tank, and into waste water outlet pipe and out of the tank 10. The treated waste water outlet pipe 14 exits the tank 10 from the upper region 35 of the tank 10.

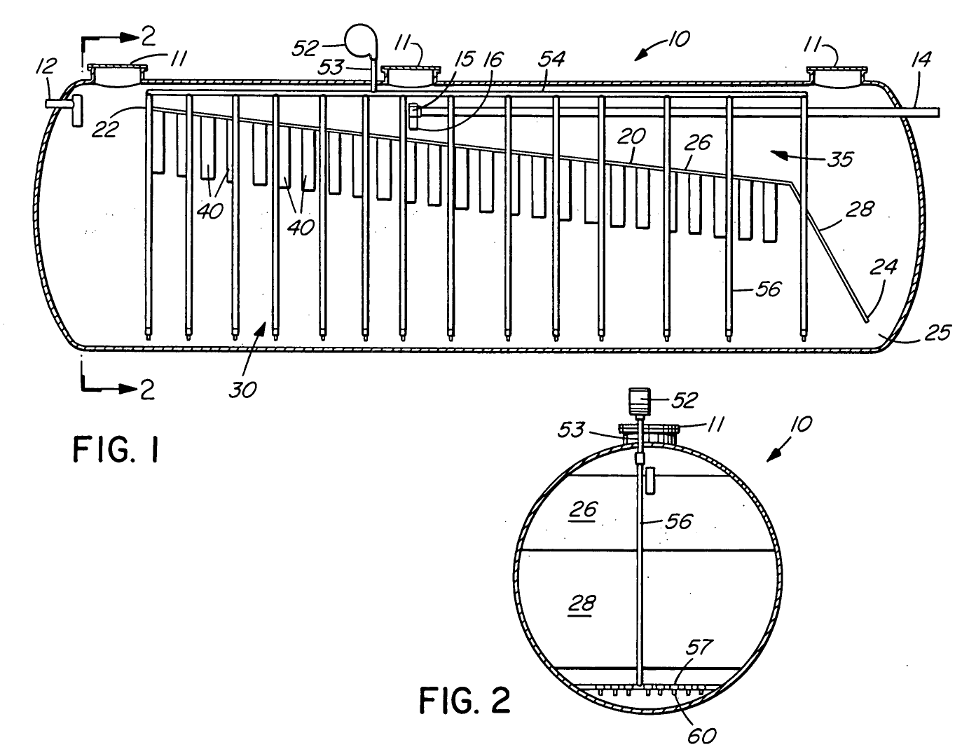

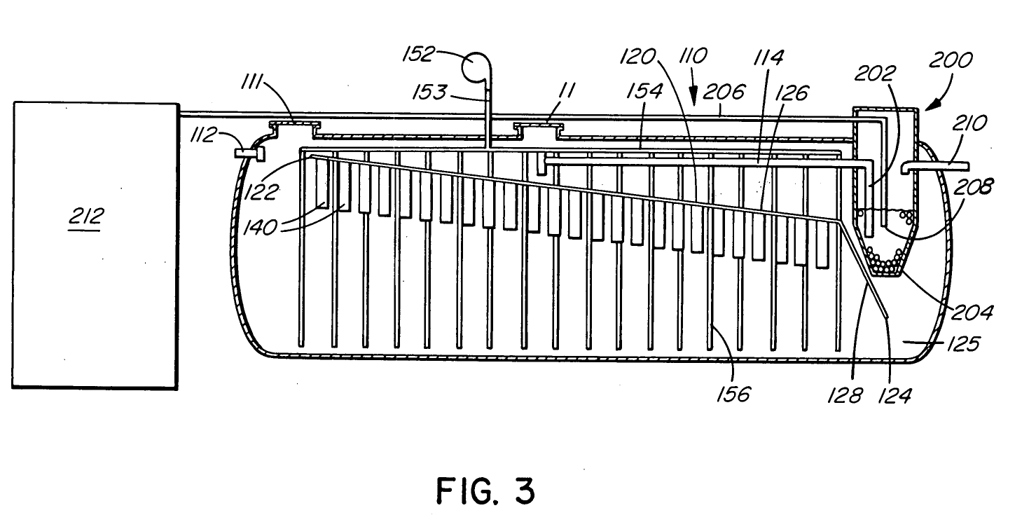

In FIG. 3 of the accompanying drawings, there is illustrated a modification of the apparatus of FIGS. 1 and 2, in which parts which are identical to those of FIGS. 1 and 2 are indicated by corresponding reference numerals increased by 100 and, for convenience, are not further described herein.

More particularly, the tank 10 of FIGS. 1 and 2 has been modified in FIG. 3 by the addition of a clarification chamber, indicated generally by reference numeral 200, which is located at the right-hand end of tank 110, as viewed in FIG. 4. Outlet duct 114, in this embodiment of the present invention, instead of extending from the tank as in the embodiment of FIGS. 1 and 2, has a vertical end portion 202 which, within the clarification chamber 200, extends downwardly into an accumulation of bacterial growth media in the form of plastic beads 204.

Pump 152 supplies air through vertical air supply duct 153, to a horizontal air supply duct 206, which has an open end 208 for discharging air into the accumulation of plastic beads 204 to promote bacterial digestion of organic substances in the waste water in a manner well known in the art. Clarified water leaves the clarification chamber 200 through a treated waste water outlet in the form of an outlet pipe 210.

Horizontal air supply duct 206 also communicates with the interior of a trash tank 212 serving as a settlement tank for the preliminary removal of solid materials from the waste water.

The apparatus shown in FIG. 3 functions as follows:—

Untreated waste water is introduced into the tank 110 via the waste water inlet pipe 110 is treated by aerobic digestion within the tank 110 in a manner similar to that described above with reference to FIGS. 1 and 2.

However, instead of then being discharged directly from the tank 110, the treated waste water is fed through the vertical end portion 202 of the outlet duct 114 into the accumulation of plastic beads 204 within the clarifying chamber 200, where the waste water is subjected to further aerobic treatment before being discharged through the outlet pipe 210.

As will be apparent to those skilled in the art, various modifications may be made in the above-described backwash system and method of treating and backwashing waste water within the scope of the appended claims.

I claim:

1. A waste water treatment apparatus, comprising:—
a treatment tank;
a solids retainer baffle extending across the interior of the tank and inclined downwardly and longitudinally of the tank, the baffle separating the tank into an upper region and a lower region;
the baffle having a lower end in the vicinity of the inner surface of the tank so as to define therewith a liquid escape gap communicating with the upper region of the tank;
a waste water inlet duct communicating with the lower region of the tank;
a waste water outlet duct;
a plurality of air outlets located in the lower region of the tank;
an air supply ductwork communicating with the air outlets;
a compressed air source communicating with through the air supply ductwork with the air outlets; and
a microbe growth medium located between the baffle and the air outlets.

2. A waste treatment apparatus as claimed in claim 1, wherein the microbe growth medium extends downward from the baffle into the lower region of the tank.

3. A waste water treatment apparatus as claimed in claim 1, including a treatment chamber, bacterial growth media in the treatment chamber, the waste water outlet and a further air inlet extending into treatment chamber and a treated water outlet extending from the treatment chamber.

4. A method of treating waste water in an aerobic waste water treatment tank, comprising the steps of:
separating the interior of the tank into an upper region and a lower region by a baffle extending across and inclined longitudinally downwardly of the interior of the tank;
introducing untreated waste water into the lower region of the tank;
supplying air into the lower region of the tank to effect aerobic digestion of the the untreated waste water through microbes on a microbe growth medium in the lower region of the tank;
allowing treated waste water to flow past a lower end of the baffle into the upper region of the tank while retaining solids from the waste water in the lower region of the tank by means of the baffle; and
removing treated water from the upper region of the tank.

5. A method of treating waste water as claimed in claim 4, which includes feeding the treated waste water from the upper region of the tank into a further treatment chamber and effecting further aerobic treatment of the waste water within the further treatment chamber.
